(19) United States
(12) Patent Application Publication
(10) Pub. No.: US 2024/0272342 A1
(43) Pub. Date: Aug. 15, 2024

(54) POLARIZING PLATE AND OPTICAL DISPLAY APPARATUS

(71) Applicant: SAMSUNG SDI CO., LTD., Yongin-si (KR)

(72) Inventors: Yoo Jin KIM, Suwon-si (KR); Ji Hyun WI, Suwon-si (KR); Min Jeong PARK, Suwon-si (KR); Han Su KIM, Suwon-si (KR); Eun Mi KIM, Suwon-si (KR); A Ra JO, Suwon-si (KR)

(21) Appl. No.: 18/431,879

(22) Filed: Feb. 2, 2024

(30) Foreign Application Priority Data
Feb. 9, 2023 (KR) 10-2023-0017291

(51) Int. Cl. G02B 5/30; G02B 1/111

(52) U.S. Cl. CPC G02B 5/305; G02B 1/111

(57) ABSTRACT

A polarizing plate and an optical display apparatus including the same are disclosed. A polarizing plate includes: a polarizer; and an optical stack on a surface of the polarizer, the optical stack including an antiglare layer, and the polarizing plate has an external haze of greater than 30%, an internal haze of less than 10%, a 60 degree gloss of 10 GU or less, and a 60 degree gloss-to-85 degree gloss ratio (60 degree gloss/85 degree gloss) of 0.2 or less.

### CROSS-REFERENCE TO RELATED APPLICATION

The present application claims priority to and the benefit of Korean Patent Application No. 10-2023-0017291, filed on Feb. 9, 2023 in the Korean Intellectual Property Office, the entire disclosure of which is incorporated herein by reference.

### BACKGROUND

### 1. Field

Aspects of embodiments of the present invention relate to a polarizing plate and an optical display apparatus.

### 2. Description of the Related Art

The primary function of an optical display apparatus that displays a screen, such as a TV or computer, is to realize a high-quality screen upon operation of the optical display apparatus. However, in recent years, as TVs and computers have been used for various purposes in various places, a screen is often placed in a standby state prior to being displayed even when a display apparatus is running. In general, when a screen on a TV or computer is in a standby state, the screen may be in dark mode, but it can also function as a picture frame by reproducing a picture or photo, such as an oil painting.

If an oil painting or photo or the like displayed on a screen is not clear and loses an original texture thereof, this inevitably reduces preference for corresponding TV or computer products regardless of how good their primary function is. Further, if a screen in dark mode has high reflectivity to external light and thus reflects surrounding objects thereon, this can reduce consumer preference.

A polarizing plate is an essential component of an optical display apparatus such as a TV or computer. Many technologies are under development to solve these problems through adjustment of the polarizing plate. However, these technologies are limited in ability to overcome the above problems and also lack ability to realize a completely black screen which does not reflect anything therearound.

The background technique of the present invention is disclosed in Korean Patent Registration No. 10-2120989.

### SUMMARY

According to an aspect of embodiments of the present invention, a polarizing plate that can prevent reduction in display luminance and can provide a completely black screen not reflecting anything therearound is provided.

According to another aspect of embodiments of the present invention, a polarizing plate that can prevent reduction in display luminance and allows a picture or photo, such as an oil painting, displayed on a screen of an optical display apparatus to have a clear and matte texture without losing an original texture thereof is provided.

According to an aspect of one or more embodiments of the present invention, a polarizing plate is provided.

According to one or more embodiments, a polarizing plate includes: a polarizer; and an optical stack on a surface of the polarizer, the optical stack including an antiglare layer, wherein the polarizing plate has an external haze of greater than 30%, an internal haze of less than 10%, a 60 degree gloss of 10 GU or less, and a 60 degree gloss-to-85 degree gloss ratio (60 degree gloss/85 degree gloss) of 0.2 or less.

In one or more embodiments, the polarizing plate may have an 85 degree gloss of 50 GU or less.

In one or more embodiments, the polarizing plate may have an external haze-to-internal haze ratio of 5 or more.

In one or more embodiments, the optical stack may have an external haze less than or equal to that of the polarizing plate.

In one or more embodiments, the optical stack may have an internal haze less than or equal to that of the polarizing plate.

In one or more embodiments, the optical stack may have a 60 degree gloss greater than that of the polarizing plate.

In one or more embodiments, the optical stack may have an 85 degree gloss greater than or equal to that of the polarizing plate.

In one or more embodiments, the polarizer may include a polyvinyl alcohol-based film containing a hydrophilic functional group and a hydrophobic functional group.

In one or more embodiments, the antiglare layer may have roughness on an outermost surface thereof.

In one or more embodiments, the antiglare layer may have a surface roughness of 1,000 nm or less.

In one or more embodiments, in the antiglare layer, a content of inorganic particles alone, a content of organic particles alone, or a total content of inorganic particles and organic particles may be 0.5 wt % or less.

In one or more embodiments, the optical stack may include a base layer, the antiglare layer, and an antireflection layer stacked in sequence.

In one or more embodiments, the antireflection layer may have a surface roughness of 200 nm or less.

In one or more embodiments, the polarizing plate may further include a protective layer.

According to another aspect of one or more embodiments of the present invention, an optical display apparatus is provided.

According to one or more embodiments, an optical display apparatus includes the polarizing plate according to an embodiment, as set forth above.

Embodiments of the present invention provide a polarizing plate that can prevent reduction in display luminance and can provide a completely black screen not reflecting anything therearound.

Further, embodiments of the present invention provide a polarizing plate that can prevent reduction in display luminance and allows a picture or photo, such as an oil painting, displayed on a screen of an optical display apparatus to have a clear and matte texture without losing an original texture thereof.

### BRIEF DESCRIPTION OF THE DRAWINGS

FIG. 1 is a cross-sectional view of a polarizing plate according to an embodiment of the present invention.

FIG. 2 is a cross-sectional view of a polarizing plate according to another embodiment of the present invention.

FIG. 3A and FIG. 3B show results of evaluation as to a matte texture for a polarizing plate of Example 1 and a polarizing plate of Comparative Example 1, respectively.

FIG. 4A and FIG. 4B show results of evaluation as to a matte texture for the polarizing plate of Example 1 and the polarizing plate of Comparative Example 1, respectively.

FIG. 5A and FIG. 5B show results of evaluation as to a black visibility for the polarizing plate of Example 1 and the polarizing plate of Comparative Example 1, respectively.

### DETAILED DESCRIPTION

Herein, embodiments of the present invention will be described in further detail with reference to the accompanying drawings such that the present invention can be implemented by those skilled in the art. However, it is to be understood that the present invention may be embodied in different ways and is not limited to the following embodiments.

The terminology used herein is for the purpose of describing example embodiments and is not intended to limit the present invention. As used herein, the singular forms “a,” “an,” and “the” are intended to include the plural forms as well, unless the context clearly indicates otherwise.

In the drawings, portions irrelevant to the description may be omitted for clarity, and like components are denoted by like reference numerals throughout the specification. Although lengths, thicknesses or widths of various components may be exaggerated in the drawings for clarity of description of the present invention, the present invention is not limited thereto.

Herein, spatially relative terms, such as “upper” and “lower,” are defined with reference to the accompanying drawings. Thus, it is to be understood that “upper surface” can be used interchangeably with “lower surface.”

Herein, “in-plane retardation (Re)” is a value calculated according to the following Equation A:

$$Re = ( n x - n y ) \times d , \qquad Equation A$$

where nx and ny are the indexes of refraction of an optical element, as measured in the slow axis- and fast axis-directions thereof at a wavelength of 550 nm, respectively, and d is the thickness (unit: nm) of the optical element.

Herein, “internal haze” of a polarizing plate is a value measured in the same manner as in measurement of total haze of the polarizing plate after alcohol, for example, ethanol, is sprayed onto a glass plate having a total haze of less than 1%, followed by adhering an optical stack of the polarizing plate to the glass plate to flatten unevenness of the optical stack surface.

Herein, “total haze” of a polarizing plate is a value measured by a typical haze meter, for example, a haze meter NHD-2000, with respect to the polarizing plate.

Herein, “external haze” of a polarizing plate may be a difference between the total haze of the polarizing plate and the internal haze thereof.

Herein, “haze” may be measured in the visible spectrum, for example, at a wavelength of 380 nm to 780 nm and refers to an average haze unless otherwise noted.

Herein, “total haze,” “internal haze,” and “external haze” of each of an optical stack, an antiglare layer, and an antireflection layer may be measured in the same manner as in measurement of the total haze, internal haze, and external haze of a polarizing plate.

Herein, “gloss” of a polarizing plate may be measured using a gloss meter, for example, a micro-gloss meter Micro TRI-gloss (BYK-Gardner Co.), in accordance with the following method.

### Gloss Measurement Method

A polarizing plate is cut to a size of 10 cm×10 cm (length×width) and then attached to a dark acrylic plate (PH10, Nitto Denko Co., Ltd.) with an optical stack facing away from the dark acrylic plate, followed by measurement of gloss using a gloss meter. Here, light is directed from the optical stack side toward a polarizer.

Herein, “surface irregularity” or “surface roughness” is a value measured using a two- or three-dimensional profile of surface features, refers to an Ra value unless otherwise noted, and may be measured using a surface roughness meter (VK Analyzer, KEYENCE Corp.).

Herein, “specular component excluded (SCE) reflectance” and “specular component included (SCI) reflectance” of a polarizing plate may be measured using, for example, a surface reflectance meter (CM-2600D, Konica Minolta Co., Ltd.) in accordance with the following methods:

### SCE Reflectance and SCI Reflectance Measurement Method

A polarizing plate is cut to a size of 10 cm×10 cm (length×width) and then attached to a dark acrylic plate (PH10, Nitto Denko Co., Ltd.) with an optical stack facing away from the dark acrylic plate, followed by measurement of reflectance using a surface reflectance meter CM-2600D.

Herein, “SCE reflectance/SCI reflectance” may be in a range of 0.5 to 1.0, for example, 0.7 to 1.0. Within this range, a polarizing plate can maximize or increase black visibility of a screen through diffuse reflection and allows a picture or photo, such as an oil painting, displayed on a screen of an optical display apparatus to have a clear and matte texture without losing an original texture thereof.

Herein, “refractive index” may be a value measured in the visible spectrum, for example, at a wavelength of 550 nm.

Herein, “(meth)acrylic” may refer to acrylic and/or methacrylic.

Herein, “solid content” refers to the content of components excluding a solvent.

As used herein to represent a specific numerical range, the expression “X to Y” means “greater than or equal to X and less than or equal to Y (X≤ and ≤Y).”

The present invention provides a polarizing plate that can prevent reduction in display luminance and can provide a completely black screen not reflecting anything therearound when an optical display apparatus is in an OFF state. The present invention provides a polarizing plate that can prevent reduction in display luminance and allows a picture or photo, such as an oil painting, displayed on a screen of an optical display apparatus in an ON state to have a clear and matte texture without losing an original texture thereof. The polarizing plate according to the present invention can achieve all the desired effects described above.

In one or more embodiments, the polarizing plate according to the present invention has an external haze of greater than 30%, an internal haze of less than 10%, a 60 degree gloss of 10 GU or less, and a 60 degree gloss-to-85 degree gloss ratio (60 degree gloss/85 degree gloss) of 0.2 or less, and thus can allow a picture or photo, such as an oil painting, displayed on a screen of an optical display apparatus in an ON state to have a clear and matte texture without losing an original texture thereof while providing a completely black screen not reflecting anything therearound when the optical display apparatus is in an ON state. In other words, the polarizing plate according to the present invention provides the aforementioned effects by increasing the external haze to greater than 30% and reducing the internal haze to less than 10%, the 60 degree gloss to 10 GU or less, and the 60 degree gloss-to-85 degree gloss ratio (60 degree gloss/85 degree gloss) to 0.2 or less.

In order to provide the effects described above, among others, adjustment of the external haze, internal haze, 60 degree gloss, and 85 degree gloss of the polarizing plate is critical. In this regard, external haze is considered in terms of a matte texture. In this regard, internal haze is considered in terms of display luminance. In this regard, 60 degree gloss is considered in terms of a matte texture.

If the external haze of the polarizing plate is 30% or less, the polarizing plate can have difficulty in providing a matte texture even when the polarizing plate has an internal haze of less than 10%, a 60 degree gloss of 10 GU or less, and a 60 degree gloss-to-85 degree gloss ratio of 0.2 or less.

If the internal haze of the polarizing plate is 10% or more, the polarizing plate can cause reduction in display luminance even when the polarizing plate has an external haze of greater than 30%, a 60 degree gloss of 10 GU or less, and a 60 degree gloss-to-85 degree gloss ratio of 0.2 or less.

If the 60 degree gloss of the polarizing plate exceeds 10 GU, the polarizing plate can have difficulty in providing a matte texture even when the polarizing plate has an external haze of greater than 30%, an internal haze of less than 10%, and a 60 degree gloss-to-85 degree gloss ratio of 0.2 or less.

If the 60 degree gloss-to-85 degree gloss ratio of the polarizing plate exceeds 0.2, the polarizing plate can have difficulty in providing a matte texture even when the polarizing plate has an external haze of greater than 30%, an internal haze of less than 10%, and a 60 degree gloss of 10 GU or less.

In an embodiment, the polarizing plate may have an external haze of greater than 30% to 70% or less, for example, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70%, and, in an embodiment, 35% to 65%, and, in an embodiment, 40% to 60%. Within this range, the polarizing plate can easily achieve the desired effects of the present invention, including providing a matte texture.

In an embodiment, the polarizing plate may have an internal haze of 0% or more to less than 10%, for example, 0%, 1%, 2%, 3%, 4%, 5%, 6%, 7%, 8%, 9%, or 9.9%, and, in an embodiment, 0.5% to 9%, and, in an embodiment, 1% to 8%. Within this range, the polarizing plate can easily achieve the desired effects of the present invention, including improved display luminance.

In an embodiment, the polarizing plate may have an external haze-to-internal haze ratio of 5 or more, for example, 5, 6, 7, 8, 9, 10, 11, 12, 13, 14, 15, 16, 17, 18, 19, 20, 21, 22, 23, 24, 25, 26, 27, 28, 29, or 30, for example, 5 to 30. Within this range, the polarizing plate can easily achieve the desired effects of the present invention.

In an embodiment, the polarizing plate may have a 60 degree gloss of 0 GU to 10 GU, for example, 0 GU, 1 GU, 2 GU, 3 GU, 4 GU, 5 GU, 6 GU, 7 GU, 8 GU, 9 GU, or 10 GU, and, in an embodiment, 1 GU to 9 GU, and, in an embodiment, 1 GU to 8 GU. Within this range, the polarizing plate can easily achieve the desired effects of the present invention, including providing a matte texture.

In an embodiment, the polarizing plate may have a 60 degree gloss-to-85 degree gloss ratio of 0 to 0.2, for example, 0, 0.11, 0.12, 0.13, 0.14, 0.15, 0.16, 0.17, 0.18, 0.19, or 0.2, and, in an embodiment, greater than 0 to 0.2, or 0.05 to 0.2, and, in an embodiment, 0.1 to 0.2. Within this range, the polarizing plate can easily achieve the desired effects of the present invention, including providing a matte texture.

In an embodiment, the polarizing plate may have an 85 degree gloss of 50 GU or less, for example, 20 GU, 21 GU, 22 GU, 23 GU, 24 GU, 25 GU, 26 GU, 27 GU, 28 GU, 29 GU, 30 GU, 31 GU, 32 GU, 33 GU, 34 GU, 35 GU, 36 GU, 37 GU, 38 GU, 39 GU, 40 GU, 41 GU, 42 GU, 43 GU, 44 GU, 45 GU, 46 GU, 47 GU, 48 GU, 49 GU, or 50 GU, and, in an embodiment, 20 to 50 GU, and, in an embodiment, 20 to 40 GU. Within this range, the polarizing plate can easily achieve the desired effects of the present invention, including providing a matte texture.

In an embodiment, the polarizing plate may have an total haze of 30% to 80%, such as 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or 80%, and, in an embodiment, 40% to 60%. Within this range, the polarizing plate can easily achieve the desired effects of the present invention, including providing a matte texture.

In an embodiment, the polarizing plate may have a 20 degree gloss of 0 GU to 10 GU, such as 0 GU, 1 GU, 2 GU, 3 GU, 4 GU, 5 GU, 6 GU, 7 GU, 8 GU, 9 GU, or 10 GU, and, in an embodiment, 4 GU to 8 GU. Within this range, the polarizing plate can easily achieve the desired effects of the present invention, including providing a matte texture.

In particular, according to the present invention, an antiglare layer disposed on a side of the polarizing plate closest to a viewer or an optical stack including the antiglare layer is also adjusted in terms of total haze, internal haze, 60 degree gloss, and 85 degree gloss, in addition to adjustment of the total haze, internal haze, 60 degree gloss, and 60 degree gloss-to-85 degree gloss ratio of the entire polarizing plate.

The antiglare layer or the optical stack including the antiglare layer may have an external haze different from or equal to that of the polarizing plate.

The antiglare layer or the optical stack including the antiglare layer may have an internal haze different from or equal to that of the polarizing plate, and, in an embodiment, different from that of the polarizing plate.

The antiglare layer or the optical stack including the antiglare layer may have a 60 degree gloss different from or equal to that of the polarizing plate, and, in an embodiment, different from that of the polarizing plate.

The antiglare layer or the optical stack including the antiglare layer may have an 85 degree gloss different from or equal to that of the polarizing plate, and, in an embodiment, different from that of the polarizing plate.

A polarizing plate according to one or more embodiments of the present invention includes: a polarizer; and an optical stack formed on a surface of the polarizer, wherein the optical stack includes an antiglare layer.

In the following, the polarizer will be described first.

The polarizer is a linear light-absorbing polarizer and has a function of polarizing incident light by transmitting only a light component incident from a first direction and absorbing a light component incident from a direction perpendicular to the first direction.

The polarizer is formed of a polyvinyl alcohol (PVA)-based film. Herein, “polyvinyl alcohol-based” may refer to polyvinyl alcohol or a derivative thereof. In an embodiment, the polarizer is formed of a film of a derivative of polyvinyl alcohol.

In an embodiment, the polyvinyl alcohol derivative contains hydrophilic and hydrophobic functional groups. The hydrophobic functional group is present in addition to a hydroxyl (OH) group present as the hydrophilic functional group in polyvinyl alcohol. The hydrophobic functional group may be present in a main chain and/or a side chain of a polyvinyl alcohol derivative resin. The “main chain” refers to a part forming a backbone of the polyvinyl alcohol derivative, and the “side chain” refers to a part branching off of the backbone. In an embodiment, the hydrophobic functional group is present in the main chain of the polyvinyl alcohol derivative.

The polyvinyl alcohol derivative containing the hydrophilic and hydrophobic functional groups may be prepared by polymerization of at least one vinyl ester monomer, such as vinyl acetate, vinyl formate, vinyl propionate, vinyl butyrate, vinyl pivalate, and isopropenyl acetate, with a monomer providing a hydrophobic functional group. In an embodiment, the vinyl ester monomer includes vinyl acetate. The monomer providing a hydrophobic functional group may include a monomer providing a hydrocarbon repeat unit, such as ethylene and propylene.

In an embodiment, the polyvinyl alcohol-based film may have a softening point of 66° C. to 70° C., for example, 67° C. to 69ºC. Within this range, the polyvinyl alcohol-based film does not suffer from melting and fracture when stretched and can easily form the polarizer according to the present invention.

In an embodiment, the polyvinyl alcohol-based film may have a tensile strength of 95 MPa to 105 MPa, and, in an embodiment, 97 MPa to 99 MPa, as measured in a machine direction thereof. Within this range, the polyvinyl alcohol-based film does not suffer from melting and fracture when stretched, can increase the degree of polarization through effective alignment of polyvinyl alcohol molecule chains, and can easily form the polarizer according to the present invention. Tensile strength of the polyvinyl alcohol-based film may be measured at 25° C. using a universal testing machine (UTM) in accordance with ASTM D882.

The polyvinyl alcohol-based film may have a thickness of 50 μm or less, for example, 10 μm to 50 μm. Within this range, the polyvinyl alcohol resin film does not suffer from melting and fracture when stretched.

The polyvinyl alcohol-based film may be a TS-#4500 PVA film (Kuraray Co., Ltd.), without being limited thereto.

The polarizer includes a dichroic material applied thereto. The dichroic material may include an iodine-based material or a dichroic dye such as an azo dye. In general, polarizers may be classified into an iodine-based polarizer that contains an iodine-based material and a dye-based polarizer that contains a dichroic dye. In embodiments of the present invention, any of the iodine-based polarizer and the dye-based polarizer may be used as the polarizer.

In an embodiment, the polarizer may have a thickness of 20 μm or less, for example, greater than 0 μm to 20 μm or 10 μm to 20 μm. Within this range, the polarizer can be used in the polarizing plate.

In the following, a method of manufacturing the polarizer will be described in further detail.

The polarizer may be manufactured by a manufacturing method including a dyeing process, a stretching process, and a crosslinking process. In an embodiment, the polarizer may be manufactured by sequentially performing the dyeing process, the stretching process, and the crosslinking processes. In another embodiment, the stretching process may be performed before the dyeing process. In another embodiment, the crosslinking process may be performed before the stretching process. In addition, after the stretching process, a color correction process may be further performed.

### Dyeing Process

The dyeing process includes treatment of a polyvinyl alcohol-based film in a dyeing bath containing a dichroic material. In the dyeing process, the polyvinyl alcohol-based film is dipped in the dyeing bath containing the dichroic material. The dyeing bath containing the dichroic material includes an aqueous solution containing the dichroic material and a boron compound. As the dyeing bath includes both the dichroic material and the boron compound, the dyed polyvinyl alcohol-based film can be prevented from fracture when stretched under the stretching conditions described below.

The dichroic material is iodine and may include at least one selected from among potassium iodide, hydrogen iodide, lithium iodide, sodium iodide, zinc iodide, aluminum iodide, lead iodide, and copper iodide. In an embodiment, the dichroic material may be present in an amount of 0.5 mol/ml to 10 mol/ml, and, in an embodiment, 0.5 mol/ml to 5 mol/ml, in the dyeing bath, and, in an embodiment, in the dyeing solution. Within this range, uniform dyeing can be achieved.

The boron compound can assist in prevention of melting and fracture of the polyvinyl alcohol-based film upon stretching of the polyvinyl alcohol-based film. The boron compound can assist in prevention of melting and fracture of the polyvinyl alcohol-based film in the subsequent stretching process even when the polyvinyl alcohol-based film is stretched at high temperature and high stretching ratio.

The boron compound may include at least one selected from among boric acid and borax. In an embodiment, the boron compound may be present in an amount of 0.1 wt % to 5 wt %, and, in an embodiment, 0.3 wt % to 3 wt %, in the dyeing bath, and, in an embodiment, in the dyeing solution. Within this range, the polyvinyl alcohol-based film does not suffer from melting and fracture in the stretching process and can achieve high reliability.

The dyeing solution may have a temperature of 20° C. to 50° C., and, in an embodiment, 25° ° C. to 40° C. The dyeing process may be performed by dipping the polyvinyl alcohol-based film in the dyeing bath for 30 seconds to 120 seconds, and, in an embodiment, 40 seconds to 80 seconds.

### Stretching Process

The stretching process includes stretching the dyed polyvinyl alcohol-based film at a stretching ratio of at least 5.7 times, for example, 5.7 times to 7 times, at a temperature of 57° C. or more, for example, at 57° C. to 65° C. In the case of conventional polyvinyl alcohol-based films, stretching at the stretching ratio and the temperature results in failure to manufacture a polarizer due to melting and/or fracture of the polyvinyl alcohol-based films.

The stretching process is performed by either wet stretching or dry stretching. In an embodiment, the stretching process includes wet stretching to apply the boron compound in the stretching process. Wet stretching includes uniaxial stretching of the polyvinyl alcohol-based film in the machine direction in an aqueous solution containing a boron compound.

The boron compound may include at least one selected from among boric acid and borax. In an embodiment, the boron compound may be present in an amount of 0.5 wt % to 10 wt %, and, in an embodiment, 1 wt % to 5 wt %, in a stretching bath, and, in an embodiment, in the stretching solution. Within this range, the polyvinyl alcohol-based film does not suffer from melting and fracture in the stretching process and can achieve high reliability.

### Crosslinking Process

The crosslinking process is performed to enhance adsorption of the dichroic material to the stretched polyvinyl alcohol-based film. A crosslinking solution used in the crosslinking process includes a boron compound. The boron compound can assist in enhancing adsorption of the dichroic material described above while improving reliability of the polarizer even when the polarizer is left under a thermal shock condition.

The boron compound may include at least one selected from among boric acid and borax. In an embodiment, the boron compound may be present in an amount of 0.5 wt % to 10 wt %, and, in an embodiment, 1 wt % to 5 wt %, in a crosslinking bath, and, in an embodiment, in the crosslinking solution. Within this range, the polyvinyl alcohol-based film does not suffer from melting and fracture in the stretching process and can achieve high reliability. The crosslinking bath may have a temperature of 20° C. to 50° C., and, in an embodiment, 25° C. to 40° C. The crosslinking process may be performed by dipping the polyvinyl alcohol-based film in the crosslinking bath for 30 seconds to 120 seconds, and, in an embodiment, for 40 seconds to 80 seconds.

### Color Correction Process

The color correction process can improve durability of the polarizer.

The color correction process may be performed by dipping and leaving the polyvinyl alcohol-based film in a color correction bath. The color correction bath may contain potassium iodide. The potassium iodide may be present in an amount of greater than 0 wt % to 10 wt %, and, in an embodiment, 1 wt % to 5 wt %. Within this range, the polarizer according to the present invention can be easily obtained.

The polyvinyl alcohol-based film may be subjected to a washing process and/or a swelling process before the dyeing process.

In the washing process, the polyvinyl alcohol-based film is washed with water to remove foreign matter from the polyvinyl alcohol-based film.

In the swelling process, the polyvinyl alcohol-based film is dipped in a swelling bath in a certain temperature range (e.g., a predetermined temperature range) to facilitate dyeing with the dichroic material and stretching. The swelling process may be performed at 15° C. to 35° C., and, in an embodiment, at 20° C. to 30° C., for 30 seconds to 50 seconds.

In the following, the optical stack will be described.

The optical stack includes a base layer, an antiglare layer, and an antireflection layer.

In an embodiment, the optical stack has a structure in which the antiglare layer and the antireflection layer are stacked in sequence on the base layer. In an embodiment, the optical stack may have a three-layer structure including the base layer, the antiglare layer, and the antireflection layer.

The optical stack may have an external haze of 30% or more, for example, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or 70%, and, in an embodiment, 30% to 70%, and, in an embodiment, 40% to 60%, 45% to 60%, or 50% to 60%. Within this range, the polarizing plate can easily reach the external haze according to the present invention.

The optical stack may have an internal haze of 10% or less, for example, 0%, 1%, 2%, 3%, 4%, 5%, 6%, 7%, 8%, 9%, or 10%, and, in an embodiment, 0% to 10%, and, in an embodiment, 2% to 8%, or 2 to 5%. Within this range, the polarizing plate can easily reach the internal haze according to the present invention.

The optical stack may have a 60 degree gloss of 10 GU or less, for example, 1 GU, 2 GU, 3 GU, 4 GU, 5 GU, 6 GU, 7 GU, 8 GU, 9 GU, or 10 GU, and, in an embodiment, 1 GU to 9 GU, and, in an embodiment, 2 GU to 8 GU. Within this range, the polarizing plate can easily reach the 60 degree gloss according to the present invention.

The optical stack may have an 85 degree gloss of 50 GU or less, for example, 10 GU, 11 GU, 12 GU, 13 GU, 14 GU, 15 GU, 16 GU, 17 GU, 18 GU, 19 GU, 20 GU, 21 GU, 22 GU, 23 GU, 24 GU, 25 GU, 26 GU, 27 GU, 28 GU, 29 GU, 30 GU, 31 GU, 32 GU, 33 GU, 34 GU, 35 GU, 36 GU, 37 GU, 38 GU, 39 GU, 40 GU, 41 GU, 42 GU, 43 GU, 44 GU, 45 GU, 46 GU, 47 GU, 48 GU, 49 GU, or 50 GU, and, in an embodiment, 10 GU to 50 GU, and, in an embodiment, from 20 GU to 40 GU, or 30 to 40 GU. Within this range, the polarizing plate can easily reach the 85 degree gloss according to the present invention.

In an embodiment, the external haze of the optical stack may be less than or equal to that of the polarizing plate, wherein a difference therebetween may be 2% or less, for example, 0% to 2%. Within this range, manufacture of the polarizing plate according to the present invention can be facilitated.

In an embodiment, the internal haze of the optical stack may be less than or equal to that of the polarizing plate, wherein a difference therebetween may be 1% or less, for example, 0% to 1%. Within this range, manufacture of the polarizing plate according to the present invention can be facilitated.

In an embodiment, the 60 degree gloss of the optical stack may be greater than that of the polarizing plate, wherein a difference therebetween may be 1 GU or less, for example, greater than 0 GU to 1 GU. Within this range, manufacture of the polarizing plate according to the present invention can be facilitated.

In an embodiment, the 85 degree gloss of the optical stack may be greater than or equal to that polarizing plate, wherein a difference therebetween may be 2 GU or less, for example, 0 GU to 2 GU. Within this range, manufacture of the polarizing plate according to the present invention can be facilitated.

In the following, each layer constituting the optical stack will be described in further detail.

### Base Layer

The base layer may support the antiglare layer.

In an embodiment, the base layer may have an external haze of 3% or less, for example, 1.5% or less, and an internal haze of 3% or less, for example, 1.5% or less. Within this range, the base layer does not affect the external haze and internal haze of the optical stack.

The base layer may have a higher refractive index than each of the antiglare layer and the antireflection layer. In an embodiment, the base layer may have a refractive index of 1.5 to 1.8, and, in an embodiment, 1.55 to 1.75, or 1.6 to 1.7.

In an embodiment, the base layer may have a thickness of 15 μm to 250 μm, and, in an embodiment, 25 μm to 75 μm. Within this range, the base layer can function as a support for the optical film.

The base layer may be a zero-retardation film having a substantially zero in-plane retardation at a wavelength of 550 nm, or may have an in-plane retardation in a certain range (e.g., a predetermined range). In an embodiment, the base layer may have an in-plane retardation of at least 30 nm, for example, 50 nm to 2,000 nm, at a wavelength 550 nm.

The base layer may include an optically clear base film, for example, a base film having a light transmittance of at least 90% in the visible spectrum. The base layer may further include a functional layer formed on at least one surface of the base film.

In an embodiment, the base layer may be composed of the base film alone. The base film may be a film including an optically clear resin. For example, the base film may be a film formed of at least one selected from among cellulose based resins including triacetylcellulose (TAC) and the like, polyester based resins including polyethylene terephthalate (PET), polybutylene terephthalate, polyethylene naphthalate, and the like, acrylic resins, cyclic polyolefin based resins, polycarbonate based resins, polyethersulfone based resins, polysulfone based resins, polyamide based resins, polyimide based resins, polyolefin based resins, polyarylate based resins, polyvinyl alcohol based resins, polyvinyl chloride based resins, and polyvinylidene based chloride resins. In an embodiment, the base film is a triacetylcellulose film, a polyethylene terephthalate film, or an acrylic film.

The base film may be uniaxially or biaxially stretched to provide the in-plane retardation described above. The base film may be prepared by preparing a non-stretched film from a composition for base films including the resin and stretching the non-stretched film uniaxially in the MD, uniaxially in the TD, or biaxially in the MD and the TD. The stretching ratio may be suitably selected in consideration of the thickness of the non-stretched film, target in-plane retardation, stretching temperature, and the like. For example, the stretching ratio may be set to 2 to 7 times, or 3 to 8 times. The stretching temperature may be adjusted according to the glass transition temperature (Tg) of the non-stretched film, for example, Tg±20° C. Stretching may be performed by a typical method known to those skilled in the art.

In an embodiment, the base layer may further include a primer layer as a functional layer. The primer layer serves to enhance adhesion to an adherend or the antiglare layer. The primer layer may be formed of a composition including a resin for the primer layer, such as a urethane resin, an acrylic resin, and a polyester resin, without altering the desired effects of the optical stack.

### Antiglare Layer

The antiglare layer can assist in providing the external haze, internal haze, 60 degree gloss, and 60 degree gloss-to-85 degree gloss ratio of the polarizing plate.

The antiglare layer may have a higher refractive index than the antireflection layer to make it easy to provide reflectance according to the present invention.

In an embodiment, the antiglare layer may have roughness on an outermost surface thereof, that is, at an interface between the antiglare layer and the antireflection layer. For example, the surface roughness may be irregular. In an embodiment, the antiglare layer may have a surface roughness of 1,000 nm or less, for example, 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, or 1,000 nm, and, in an embodiment, 100 nm to 900 nm, 200 nm to 800 nm, 500 nm to 800 nm, 600 nm to 800 nm, or 700 to 800 nm. Within this range, the polarizing plate can easily reach the external haze, internal haze, and gloss according to the present invention.

The surface roughness can be realized even when the antiglare layer contains substantially no inorganic and organic particles. That is, in the antiglare layer, a content of inorganic particles alone, a content of organic particles alone, or a total content of inorganic and organic particles may be 0.5 wt % or less, for example, 0 wt % to 0.5 wt %, or 0 wt % to 0.001 wt %, and, in an embodiment, 0 wt %.

In the absence of inorganic and organic particles, the surface roughness of the antiglare layer may be formed by a typical method known to those skilled in the art. For example, a composition for the antiglare layer may be interposed between an embossed die and the base layer, followed by curing the composition to form fine roughness, thereby manufacturing an antiglare film in which the antiglare layer having the surface roughness is formed on the base layer. In an embodiment, an embossed pattern is formed on the surface of the antiglare layer by sand blasting or bead (shot) blasting using a chromium-plated steel roller. In addition, the surface with the embossed pattern formed thereon may be plated with chromium before use to improve durability during use and to provide hardness and anti-corrosion properties to the antiglare film.

A roll of a film having surface roughness may be manufactured by manufacturing an embossed roll by bead (shot) blasting, forming a metal plating layer on a surface of the embossed roll, mirror-polishing a surface of the metal plating layer, subjecting the mirror-polished surface of the metal plating layer to blasting with ceramic beads, and, optionally, subjecting the metal plating layer to peening.

The composition for the antiglare layer may include: at least one selected from among a curable resin, a curable monomer and a curable oligomer; and an initiator. The composition for the antiglare layer may further include an additive.

The composition for the antiglare layer may be heat curable or curable by actinic radiation.

The curable resin may include at least one selected from among a heat-curable resin and an actinic radiation-curable resin. In an embodiment, the curable resin is an actinic radiation-curable resin to ensure easy formation of the antiglare layer and reliability of surface roughness on the antiglare layer.

The actinic radiation-curable resin refers to a resin that is crosslinked and cured by actinic radiation, such as UV light or electron beam radiation. The actinic radiation-curable resin may be selected such that a matrix of the antiglare layer can have a desired refractive index after curing. For example, the actinic radiation-curable resin may include acrylic resins, urethane resins, polyester resins, epoxy resins, epoxy (meth)acrylate resins, urethane (meth)acrylate resins, and the like. In an embodiment, the actinic radiation-curable resin is a urethane (meth)acrylate resin, and, in an embodiment, a multifunctional urethane (meth)acrylate resin.

The curable monomer and the curable oligomer can improve applicability of the composition for the antiglare layer through reduction in viscosity of the composition while increasing a curing rate of the composition. Each of the curable monomer and the curable oligomer may be thermally curable or curable by actinic radiation.

The actinic radiation-curable monomer refers to a monomer that is crosslinked and cured by actinic radiation, such as UV light or electron beam radiation. The actinic radiation-curable monomer can increase the curing rate of the composition for the antiglare layer while increasing dispersion of organic particles. For example, the actinic radiation-curable monomer may be selected such that the matrix of the antiglare layer can have a desired refractive index after curing. For example, the actinic radiation-curable monomer may include a bi- to deca-functional, for example, bi- to hexa-functional (meth)acrylate monomer. The bi- to deca-functional (meth)acrylate monomer may be selected from any type known those skilled in the art. For example, the actinic radiation-curable monomer may include: a bifunctional acrylate, such as tricyclodecane dimethanol di(meth)acrylate, 1,6-hexanediol di(meth)acrylate, neopentylglycol di(meth)acrylate, polyethylene glycol di(meth)acrylate, neopentyl glycol adipate di(meth)acrylate, ethoxylated bisphenyl fluorene di(meth)acrylate; a trifunctional (meth)acrylate, such as trimethylolpropane tri(meth)acrylate, dipentaerythritol tri(meth)acrylate, pentaerythritol tri(meth)acrylate, and propylene oxide-modified trimethylolpropane tri(meth)acrylate; a tetrafunctional acrylate, such as diglycerin tetra(meth)acrylate and pentaerythritol tetra(meth)acrylate; a pentafunctional acrylate, such as dipentaerythritol penta(meth)acrylate; and a hexafunctional acrylate, such as dipentaerythritol hexa(meth)acrylate, caprolactone-modified dipentaerythritol hexa(meth)acrylate, and a reaction product of urethane (meth)acrylate (for example, isocyanate monomer) and trimethylolpropane tri(meth)acrylate, without being limited thereto.

The initiator may include at least one selected from among a photoinitiator and a thermal initiator. The photoinitiator may include at least one selected from among a photo-radical initiator and a photo-cationic initiator. The photoinitiator can cure the actinic radiation-curable resin, the actinic radiation-curable monomer, and the actinic radiation-curable oligomer. The photo-radical initiator may include any of an acetophenone-based initiator and a cyclohexylketone-based initiator, without being limited thereto.

The additive may include at least one selected from among additives commonly used in optical films, such as a dispersant, a surfactant, a light stabilizer, a UV absorber, and a heat stabilizer. In an embodiment, the additive includes a dispersant to prevent or substantially prevent agglomeration of organic particles in the antiglare layer.

In an embodiment, the composition for the antiglare layer may include 60 wt % to 98 wt %, and, in an embodiment, 92 wt % to 98 wt %, of at least one selected from the curable monomer and the curable oligomer as the curable resin, 1 wt % to 5 wt %, and, in an embodiment, 2 wt % to 4 wt %, of the initiator, and 0.05 wt % to 3 wt %, and, in an embodiment, 0.1 wt % to 1.5 wt %, of the additive, in terms of solid content. Within this range, the antiglare layer can easily reach the refractive index according to the present invention and can be cured at an increased rate, thereby improving mechanical strength of the optical stack.

The composition for the antiglare layer may include any suitable solvent. The solvent can improve applicability of the composition for the antiglare layer. The solvent may include methyl ethyl ketone and propylene glycol methyl ether, without being limited thereto.

In an embodiment, the antiglare layer may have a thickness of 2 μm to 10 μm, and, in an embodiment, 3 μm to 7 μm, and, in an embodiment, 4 μm to 6 μm. Within this range, the antiglare layer can be used in an optical display apparatus.

### Antireflection Layer

The antireflection layer may have a lower refractive index than the antiglare layer to reduce reflectivity of the polarizing plate. In an embodiment, the antireflection layer may have a refractive index of 1.4 or less, for example, 1.3 to 1.37. Within this range, the antireflection layer can easily reduce reflectivity of the polarizing plate. As a result, the polarizing plate may have an SCI reflectance of 2% or less, for example, 1.4% to 1.8%, and an SCE reflectance of 2% or less, for example, 1.4% to 1.8%. Within this range, the polarizing plate can provide a completely black screen not reflecting anything therearound even during operation of an optical display apparatus.

The antireflection layer can assist in providing the external haze, internal haze, 60 degree gloss, and 85 degree gloss of the polarizing plate. In this regard, the antireflection layer may have roughness on a surface thereof. For example, the antireflection layer may have irregular roughness on the surface thereof, which is caused by dispersion of low refractive index particles described below.

In an embodiment, the antireflection layer may have a surface roughness of 200 nm or less, for example, 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, or 200 nm, and, in an embodiment, 100 nm to 200 nm, or 120 to 180 nm. Within this range, the antireflection layer can make it easy to provide the reflectance, external haze, internal haze, and gloss of the polarizing plate.

The antireflection layer may include at least one selected from among low refractive index particles and a fluorine compound. The low refractive index particles and the fluorine-based compound can reduce the refractive index of the antireflection layer.

The low refractive index particles may be particles having a lower refractive index than the antiglare layer. For example, the low refractive index particles may be hollow to provide a low refractive index. For example, the low refractive index particles may be low refractive index inorganic particles, and, in an embodiment, hollow silica. In an embodiment, the low refractive index particles may have a refractive index of less than 1.4, for example, 1.0 to less than 1.3. Within this range, the low refractive index particles can easily reduce the refractive index of the antireflection layer.

The low refractive index particles may have a smaller average particle diameter (D50) than the thickness of the antireflection layer. For example, the low refractive index particles may have an average particle diameter (D50) of 20 nm to 120 nm, for example, 40 nm to 100 nm. Within this range, the low refractive index particles can be contained in the antireflection layer.

In an embodiment, the low refractive index particles may be present in an amount of 30 wt % to 70 wt %, for example, 35 wt % to 55 wt %, in the antireflection layer. Within this range, the polarizing plate can easily reach the reflectance according to the present invention.

The fluorine compound can facilitate reduction of the refractive index of the antireflection layer even with a small amount of the low refractive index particles. The fluorine compound may include a fluorine-containing (meth)acrylate monomer, an oligomer thereof, or a resin thereof.

The composition for the antireflection layer may further include: at least one selected from among an actinic radiation-curable resin and an actinic radiation-curable monomer; and a photoinitiator, in addition to the low refractive index particles and the fluorine compound. The actinic radiation-curable resin and the actinic radiation-curable monomer are cured to make it easy to form a matrix of the antireflection layer and to allow the low refractive index particles to be stably contained in the antireflection layer.

The actinic radiation-curable resin, the actinic radiation-curable monomer, and the photoinitiator may be substantially the same as those described above in the antiglare layer.

In an embodiment, the composition for the antireflection layer may include 30 wt % to 60 wt % of at least one selected from among the actinic radiation-curable resin and the actinic radiation-curable monomer, 40 wt % to 60 wt % of the low refractive index particles, 0 wt % to 40 wt % of the fluorine compound, and 1 wt % to 4 wt % of the photoinitiator, in terms of solid content. Within this range, the composition can easily form the antireflection layer according to the present invention.

The composition for the antireflection layer may include any suitable solvent in an amount not dissolving the low refractive index particles. The solvent may include any of methyl ethyl ketone and propylene glycol methyl ether, without being limited thereto.

The composition for the antireflection layer may further include typical additives. For example, the additives may include any known additive that can impart an antifouling function and slimness to the antireflection layer. The additives may include at least one selected from among fluorine-containing additives and silicone-based additive as an anti-slip agent.

In an embodiment, the antireflection layer may have a thickness of 90 nm to 150 nm, and, in an embodiment, 90 nm to 120 nm. Within this range, the antireflection layer can be used in the optical stack.

The antireflection layer may be formed by applying the composition for the antireflection layer to one surface of the antiglare layer, followed by drying and curing. Curing may be performed by any typical method known to those skilled in the art, such as thermal curing and photocuring.

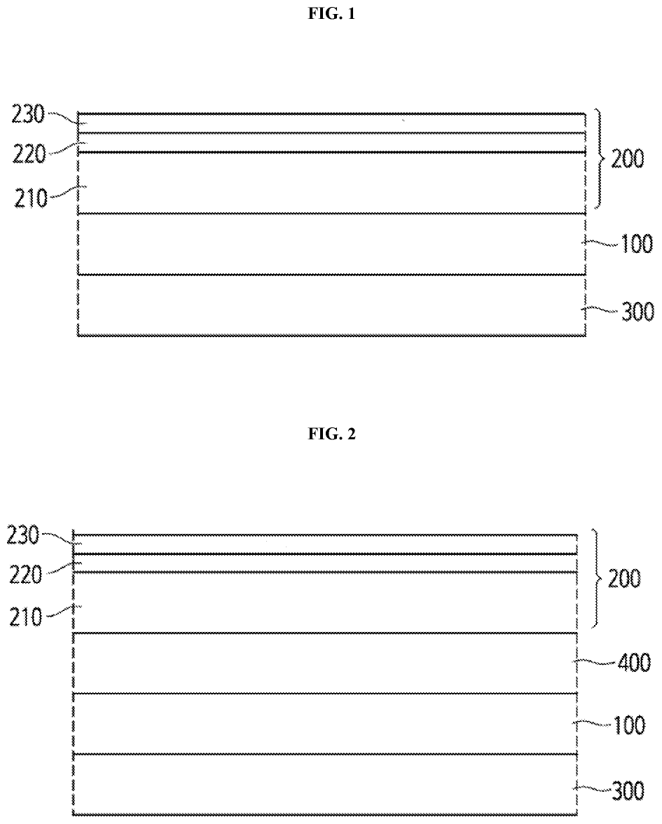

Referring to FIG. 1, a polarizing plate according to an embodiment of the present invention may include a polarizer 100, an optical stack 200 formed on a surface of the polarizer 100, and a first protective layer 300 formed on another surface of the polarizer 100. In an embodiment, each of the optical stack 200 and the first protective layer 300 may be bonded to the polarizer 100 via a bonding layer (not shown).

In an embodiment, the optical stack 200 may include a base layer 210, an antiglare layer 220, and an antireflection layer 230.

Referring to FIG. 2, a polarizing plate according to another embodiment of the present invention may include: a polarizer 100; a second protective layer 400 and an optical stack 200 stacked in sequence on a surface of the polarizer 100; and a first protective layer 300 formed on another surface of the polarizer 100. In an embodiment, each of the optical stack 200, the first protective layer 300, and the second protective layer 400 may be bonded to the polarizer 100 via a bonding layer (not shown).

Description of the base layer with regard to the antiglare layer may be applied to each of the first protective layer 300 and the second protective layer 400.

Although each of the antiglare layer and the antireflection layer is shown as having a flat upper surface in FIG. 1 and FIG. 2, each of the antiglare layer and the antireflection layer may have roughness on the upper surface thereof.

An optical display apparatus according to one or more embodiments of the present invention includes the polarizing plate according to an embodiment of the present invention.

The optical display apparatus may include any of a liquid crystal display apparatus and a light emitting diode display apparatus, without being limited thereto.

In an embodiment, the optical display apparatus may include a backlight unit, a light source-side polarizing plate, a panel for the optical display apparatus, and a viewer-side polarizing plate stacked in sequence, wherein the viewer-side polarizing plate may include the polarizing plate according to an embodiment of the present invention.

Next, the present invention will be described in further detail with reference to some examples. However, it is to be understood that these examples are provided for illustration and are not to be construed in any way as limiting the present invention.

### Example 1

A polyvinyl alcohol-based film (TS-#4500, containing a hydrophobic functional group on a main chain thereof, thickness: 45 μm, Kuraray Co., Ltd.) washed with water having a temperature of 25° C. was subjected to swelling treatment with water having a temperature of 30° C. in a swelling bath.

After swelling treatment, the film was dipped in a dyeing bath, which contained an aqueous solution containing 1 mol/ml of potassium iodide and 1 wt % of boric acid and having a temperature of 30° C. for 65 seconds. After dyeing treatment, the film was uniaxially stretched to 6 times in the MD (machine direction) in a wet stretching bath containing a 3 wt % aqueous solution of boric acid and having a temperature of 60° C. The stretched film was treated in a crosslinking bath containing a 3 wt % aqueous solution of boric acid and having a temperature of 25° C. for 65 seconds.

After crosslinking treatment, the film was dipped in a color correction bath containing an aqueous color correction solution containing 4 wt % of potassium iodide and having a temperature of 30° C. for 10 seconds. After color correction, the film was washed with water and dried, thereby preparing a polarizer (thickness: 17 μm).

A polarizing plate was manufactured by bonding an optical stack and a protective film to opposite surfaces of the polarizer, respectively, using a photocurable bonding agent. Here, the optical stack was a film in which a triacetylcellulose film as a base film, an antiglare layer (surface roughness: 780 nm), and an antireflection layer (surface roughness: 150 nm) were stacked in sequence. As the optical stack, PFN60000SLF (external haze: 57%, internal haze: 2.0%, 60 degree gloss: 6 GU, 85 degree gloss: 38 GU, Daicel Corp.) was used. As the protective film, a cyclic olefin polymer (COP) film (ZB12 COP, Zeon Corp.) was used.

### Examples 2 and 3

Polarizing plates were manufactured in the same manner as in Example 1 except that surface roughness of the antiglare layer of the optical stack and/or surface roughness of the antireflection layer of the optical stack were changed.

### Comparative Example 1

A polarizing plate was manufactured in the same manner as in Example 1 except that a DS20S-PET film (DNP Co., Ltd.) was used instead of PFN60000SLF.

### Comparative Example 2

A polarizing plate was manufactured in the same manner as in Example 1 except that an HLAG16-PET film (DNP Co., Ltd.) was used instead of PFN60000SLF.

### Comparative Examples 3 and 4

Polarizing plates were manufactured in the same manner as in Example 1 except that a PET film (Toppan Co., Ltd.) was used instead of PFN60000SLF.

### Comparative Example 5

A polarizing plate was manufactured in the same manner as in Example 1 except that a PET film (SKC Corp.) was used instead of PFN60000SLF.

A viewer-side polarizing plate was removed from a liquid crystal panel (model number: UN55KS8000F, 55 inch Samsung UHD TV, stacking order: light source-side polarizing plate/liquid crystal panel/viewer-side polarizing plate), followed by attaching each of the polarizing plates manufactured in the Examples and Comparative Examples to the liquid crystal panel as a viewer-side polarizing plate, thereby manufacturing a test model.

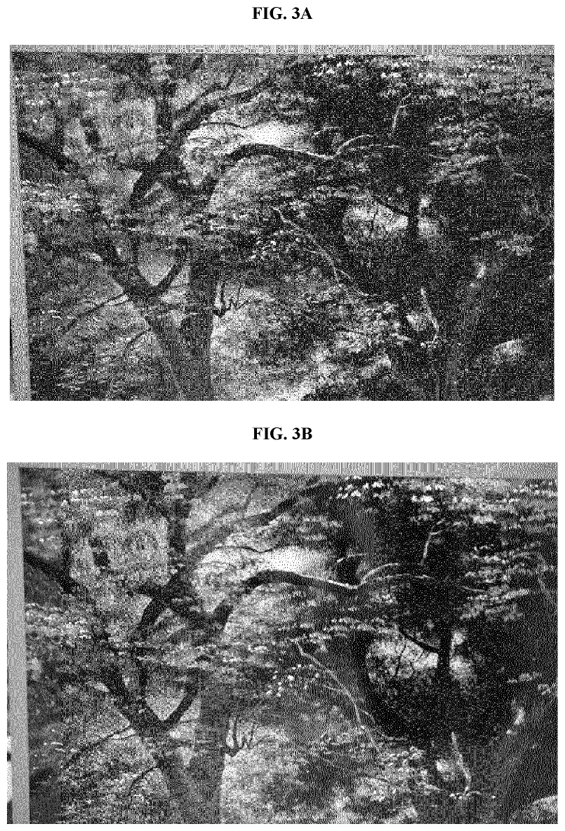

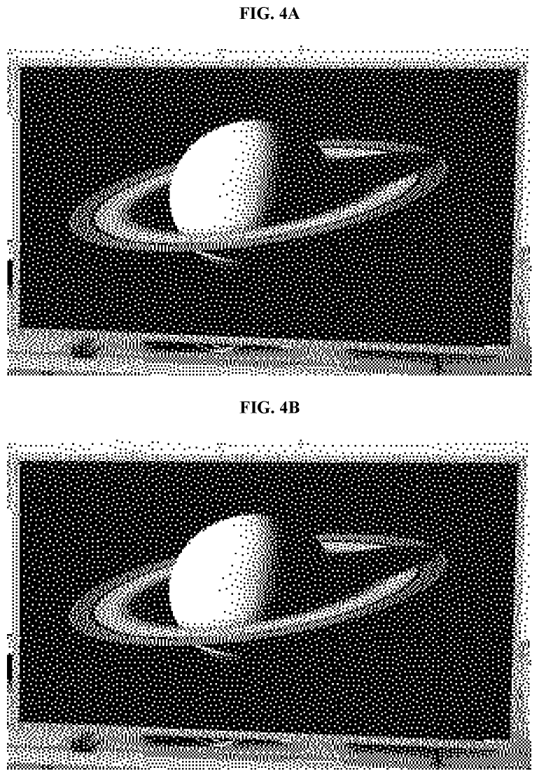

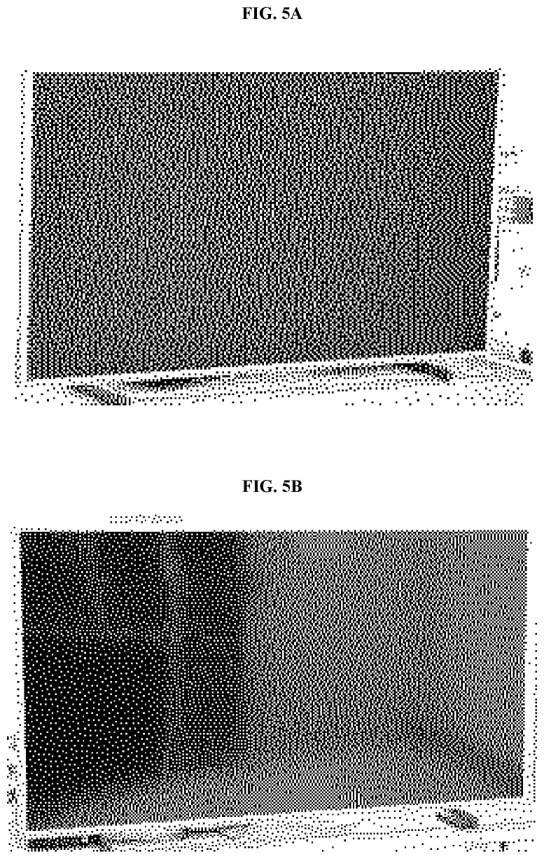

Each of the polarizing plates manufactured in the Examples and Comparative Examples was evaluated as to the following properties. Results are shown in Table 1, FIG. 3A, FIG. 3B, FIG. 4A, FIG. 4B, FIG. 5A, and FIG. 5B.

(1) Haze (unit: %): Haze of each of the polarizing plates manufactured in the Examples and Comparative Examples was measured by the method described above.

(2) Gloss (unit: %): Gloss of each of the polarizing plates manufactured in the Examples and Comparative Examples was measured by the method described above.

(3) Reflectance (unit: %): Reflectance of each of the polarizing plates manufactured in the Examples and Comparative Examples was measured by the method described above.

(4) Matte texture: each of the manufactured test models was operated to display an oil painting or a picture as shown in FIGS. 3A and 3B and FIGS. 4A and 4B, followed by measurement of the degree of clarity of the displayed image. When the displayed image was very clear, a corresponding test model was rated as ⊚, when the displayed image was slightly faint, a corresponding test model was rated as ∘, when the displayed image was somewhat faint, a corresponding test model was rated as Δ, and, when the displayed image was very faint, a corresponding test model was rated as X.

(5) Black visibility: After each of the manufactured test models was turned off, black of a screen was evaluated in the presence of external light. When the screen was completely black, a corresponding test model was rated as ⊚, when the screen was black and had very few relatively bright regions, a corresponding test model was rated as ∘, when the screen was black and had some relatively bright regions, a corresponding test model was rated as Δ, and, when the screen had many relatively bright regions, a corresponding test model was rated as X.

TABLE 1

| | Haze | | | Gloss | | | Reflectance | | | Matte | Black |
|---|---|---|---|---|---|---|---|---|---|---|---|
| | Total | External | Internal | 60° | 85° | 60°/85° | SCI | SCE | SCE/SCI | texture | visibility |
| Example 1 | 59 | 57 | 2 | 5 | 38 | 0.13 | 1.8 | 1.4 | 0.8 | ⊚ | ⊚ |
| Example 2 | 48 | 42 | 6 | 6 | 34 | 0.18 | 1.7 | 1.3 | 0.8 | ⊚ | ⊚ |
| Example 3 | 43 | 36 | 7 | 6.5 | 33.6 | 0.19 | 1.5 | 1.1 | 0.7 | ⊚ | ⊚ |
| Comparative | 3.5 | 0.5 | 3 | 91 | 98 | 0.93 | 4.6 | 0.3 | 0.1 | X | Δ |
| Example 1 | | | | | | | | | | | |
| Comparative | 2.5 | 0.5 | 2 | 54 | 91 | 0.59 | 1.5 | 0.1 | 0.1 | X | Δ |
| Example 2 | | | | | | | | | | | |
| Comparative | 74 | 9 | 65 | 20 | 69 | 0.29 | 1.3 | 0.8 | 0.6 | Δ | ◯ |
| Example 3 | | | | | | | | | | | |
| Comparative | 68 | 11 | 57 | 15 | 74 | 0.20 | 1.7 | 0.7 | 0.4 | Δ | Δ |
| Example 4 | | | | | | | | | | | |
| Comparative | 36 | 12 | 24 | 10 | 71 | 0.14 | 1.1 | 0.8 | 0.7 | Δ | ◯ |
| Example 5 | | | | | | | | | | | |

As can be seen from Table 1, the polarizing plate according to the present invention had good properties in terms of black visibility and could allow a picture or photo, such as an oil painting, displayed on a screen of an optical display apparatus to have a clear and matte texture without losing an original texture thereof.

By contrast, the polarizing plates of the Comparative Examples, which did not satisfy any of the external haze, internal haze, 60 degree gloss, and/or 60 degree gloss-to-85 degree gloss ratio according to the present invention, had poor properties in terms of black visibility and realization of a matte texture, as compared with the polarizing plates of the Examples.

This can also be confirmed from FIG. 3A, FIG. 3B, FIG. 4A, FIG. 4B, FIG. 5A, and FIG. 5B. Referring to FIGS. 3A and 4A, the polarizing plate according to the present invention could provide a matte texture, whereas, referring to FIG. 3B and FIG. 4B, the polarizing plate of Comparative Example 1 failed to realize a matte texture.

Further, referring to FIG. 5A, the polarizing plate according to the present invention had good properties in terms of black visibility, whereas, referring to FIG. 5B, the polarizing plate of Comparative Example 1 had relatively poor properties in terms of black visibility.

Although some example embodiments have been described herein, it is to be understood that various modifications, changes, alterations, and equivalent embodiments can be made by those skilled in the art without departing from the spirit and scope of the invention.

What is claimed is:

1. A polarizing plate comprising:
a polarizer; and
an optical stack on a surface of the polarizer, the optical stack comprising an antiglare layer,
wherein the polarizing plate has an external haze of greater than 30%, an internal haze of less than 10%, a 60 degree gloss of 10 GU or less, and a 60 degree gloss-to-85 degree gloss ratio of 0.2 or less.

2. The polarizing plate as claimed in claim 1, wherein the polarizing plate has an 85 degree gloss of 50 GU or less.

3. The polarizing plate as claimed in claim 1, wherein the polarizing plate has an external haze-to-internal haze ratio of 5 or greater.

4. The polarizing plate as claimed in claim 1, wherein the optical stack has an external haze less than or equal to that of the polarizing plate.

5. The polarizing plate as claimed in claim 1, wherein the optical stack has an internal haze less than or equal to that of the polarizing plate.

6. The polarizing plate as claimed in claim 1, wherein the optical stack has a 60 degree gloss greater than that of the polarizing plate.

7. The polarizing plate as claimed in claim 1, wherein the optical stack has an 85 degree gloss greater than or equal to that of the polarizing plate.

8. The polarizing plate as claimed in claim 1, wherein the polarizer comprises a polyvinyl alcohol-based film containing a hydrophilic functional group and a hydrophobic functional group.

9. The polarizing plate as claimed in claim 1, wherein the antiglare layer has roughness on an outermost surface thereof.

10. The polarizing plate as claimed in claim 9, wherein the antiglare layer has a surface roughness of 1,000 nm or less.

11. The polarizing plate as claimed in claim 9, wherein, in the antiglare layer, a content of inorganic particles alone, a content of organic particles alone, or a total content of inorganic particles and organic particles is 0.5 wt % or less.

12. The polarizing plate as claimed in claim 1, wherein the optical stack comprises a base layer, the antiglare layer, and an antireflection layer stacked in sequence.

13. The polarizing plate as claimed in claim 12, wherein the antireflection layer has a surface roughness of 200 nm or less.

14. The polarizing plate as claimed in claim 1, further comprising a protective layer.

15. An optical display apparatus comprising the polarizing plate as claimed in claim 1.
